(19) United States
(12) Patent Application Publication
(10) Pub. No.: US 2025/0373603 A1
(43) Pub. Date: Dec. 4, 2025

(54) IDENTITY DOCUMENT AUTHENTICATION

(71) Applicant: HID GLOBAL CID SAS, Suresnes (FR)

(72) Inventor: Fabrice Jogand-Coulomb, Aix en Provence (FR)

(21) Appl. No.: 18/874,010

(22) PCT Filed: Jul. 11, 2022
(86) PCT No.: PCT/IB2022/000478

§ 371 Date: Dec. 11, 2024

(51) Int. Cl. H04L 9/40

(52) U.S. Cl. CPC H04L 63/0861; H04L 63/0838

(57) ABSTRACT

Methods and systems are provided for performing operations comprising: capturing, by a client device, an image depicting an identity document, the identity document comprising biographical data and a portrait; generating a hash based on the biographical data; generating a biometric representation based on the portrait; accessing security information associated with the identity document; comparing the security information to at least one of the hash or biometric representation; and authenticating the identity document based on a result of comparing the security information to at least one of the hash or biometric representation.

### BACKGROUND

Electronic credentials are increasingly hosted in smart devices (e.g., smart phones, smart watches, and various other Internet-connected devices) and have become commonplace. Such electronic credentials are used to unlock electronic smart door locks (used, e.g., in Hotels, Enterprises), present digital identifiers of users (e.g., digital driver's licenses), and to present electronic tickets for entering ticketed events (e.g., concerts, sporting events, and so forth).

### SUMMARY

In some aspects, a method is provided comprising: capturing an image depicting an identity document, the identity document comprising biographical data and a portrait; generating a hash based on the biographical data; generating a biometric representation based on the portrait; accessing security information associated with the identity document; comparing the security information to at least one of the hash or biometric representation; and authenticating the identity document based on a result of comparing the security information to at least one of the hash or biometric representation.

In some examples, the identity document comprises an electronic identity card or electronic passport, the portrait depicting a face of a person.

In some examples, the method includes: extracting reference hash and biometric information from the security information; and comparing the reference hash and biometric information to the generated hash and biometric representation.

In some examples, the method includes: determining that the identity document is authentic in response to determining that the reference hash and biometric information corresponds to the generated hash and biometric representation.

In some examples, the method includes: determining that the identity document is not authentic in response to determining that one or more of the reference hash and biometric information fails to correspond to the generated hash and biometric representation.

In some examples, the security information is accessed from a remote server by accessing a link encoded on a reference included in the identity document.

In some examples, the security information is accessed from a local electronic device embedded in the identity document.

In some examples, the portrait includes a security layer on top of a face of a person.

In some examples, the method includes: performing object character recognition on the image to extract the biographical data; using face recognition to extract the portrait from the identity document; generating the hash based on the extracted biographical data; using the hash to access reference biometric information from a protected memory of an electronic device embedded in the identity document; verifying an issuer signature retrieved from the protected memory; confirming a retrieved identifier of electronic device matches an identifier of the electronic device stored in the protected memory; and comparing the reference biometric information to the extracted portrait to determine whether the identity document is authentic.

In some examples, accessing the security information comprises: obtaining a universal resource locator (URL) from an electronic device embedded in the identity document; and retrieving the security information from the URL.

In some examples, the electronic device provides a one-time passcode (OTP) in addition to the URL, wherein the security information is retrieved from the URL based on the OTP.

In some examples, a secure portion of an electronic device embedded in the identity document is accessed using the generated hash of the biographical data.

In some examples, a secure portion of an electronic device embedded in the identity document is accessed using a portion of the biographical data.

In some examples, the method includes: accessing a remote database storing a status indicating validity of the security information.

In some examples, a method for generating security information is provided. The method includes: using face recognition to extract a portrait from an identity document; transforming at least a portion of the extracted portrait into a reference biometric information; performing object character recognition on the identity document to extract biographical data; generating a reference hash using the extracted biographical data; and storing the reference biometric information in a protected memory using the reference hash.

In some examples, the method includes storing the security information locally on the identity document or remotely on a server.

In some examples, the method includes: retrieving an identifier of an electronic device embedded in the identity document; and signing the identifier of the electronic device, the reference biometric information, and the reference hash.

In some examples, the method includes: storing the reference hash in the protected memory.

In some examples, a system including one or more processors; and computer-readable medium including instructions executed by one or more processes are provided to perform operations of any of the above methods.

### BRIEF DESCRIPTION OF THE DRAWINGS

FIG. 1 is a block diagram of an example identity document authentication system, according to some embodiments.

FIGS. 2-5 illustrate example operations of the identity document authentication system, according to some embodiments.

FIG. 6 is a block diagram illustrating an example software architecture, which may be used in conjunction with various hardware architectures herein described.

FIG. 7 is a block diagram illustrating components of a machine, according to some example embodiments.

### DETAILED DESCRIPTION

Example methods and systems for an identity document authentication system are described. In the following description, for purposes of explanation, numerous specific details are set forth in order to provide a thorough understanding of example embodiments. It will be evident, however, to one of ordinary skill in the art that embodiments of the disclosure may be practiced without these specific details.

Typical identity documents, such as identity cards and passports, can be easily manipulated and tampered with to modify the picture and/or biographical information that is printed on the documents. For example, the birthdate can be changed to gain access to age restricted areas or the portrait can be modified to be used by another person. Also, such documents can be subject to cloning or have their security compromised for access and use by unauthorized individuals.

Many identity documents attempt to solve these issues by including a chip that encodes the biographical data and the portrait. However, such chips can be relatively expensive and cost prohibitive which makes widespread use of the identity documents with chips unmanageable. Also, if an individual gains access to the chip, the contents of the chip can be easily manipulated to reflect the fraudulent information. Some identity documents include a quick reference (QR) code that is linked to a website or universal resource locator (URL) that indicates the status of the document. Such a solution does not reflect whether the actual contents printed on the identity documents have been modified. Namely, the QR code can easily be copied onto a new or modified identity document with fraudulent information. In some systems, the QR code encodes the information that is printed on the identity document. However, such systems lack a feedback loop to verify that the content encoded by the QR code reflects what is actually printed on the identity document.

The disclosed embodiments provide an intelligent solution that addresses the above technical problems and challenges. Particularly, the disclosed technical solution ensures the printed biographical and portrait on an identity document is authentic at low to minimal cost. In some implementations, a QR code is included on (printed on) the identity document which is linked to security information. For example, the QR code is linked to security information including an encoded version of the printed information (biographical and/or portrait) of the identity document. The printed information on the identity document is read/extracted by a client device, such as a reader and is then compared with the encoded version linked to the QR code. In some cases, the portrait portion or points of the portrait with or without security elements are compared with the portrait portion linked to the QR code. If the portrait portion matches or corresponds to the portrait portion linked to the QR code, the identity document is determined to be authentic. In some examples, after, before, or simultaneous with comparing the portrait portions, the disclosed embodiments perform object character recognition (OCR) of the biographical information printed on the identity document to extract the biographical information. The disclosed embodiments then compare the extracted biographical information with the biographical information linked to the QR code. In some implementations, the authenticity of the information linked to the QR code is verified through an issuer signature. In some examples, the biographical information is combined using an encoding function within the portrait and the combination of the biographical information and portrait are compared with a combination linked to the QR code. If the two match or correspond, the identity document is determined to be authentic.

In some implementations, a low-cost device, such as an embedded chip or processor, is integrated on the identity document. The low-cost device can include minimal resources that are insufficient to encode both the biographical information and the portrait. The low-cost device may include only enough memory to store a hashed version of the biographical information and/or the portrait making such identity documents inexpensive to mass produce. This allows this solution to be deployed in a widespread manner to a large audience. In such implementations, the biographical information is extracted from the identity document (e.g., by performing OCR on the identity document). A hash of the extracted biographical information is performed and used as a password to access a secure or protected portion of the low-cost device, such as the memory of the device. From the secure or protected portion, security information is retrieved including reference biometric information (e.g., biometric template). The reference biometric information may encode one or more points of the portrait printed on the identity document including all or less than all of the points of the portrait printed on the identity document. The portrait of the identity document is then extracted and used to generate a biometric representation, such as by encoding one or more points of the portrait (e.g., based on instructions received from the security information). The encoded one or more points of the extracted portrait are compared with the reference biometric information to determine whether the identity document is authentic.

In some cases, cloning of the identity document is prevented by using an identifier of the low-cost device to encode the biographical information and portrait. In some cases, authenticity of the low-cost device or information stored thereon is protected through an issuer signature. For example, in some cases, an identifier of the low-cost device is retrieved and combined with the extracted biographical data and one or more points of the portrait to generate a signature. The signature including the combination of the low-cost device identifier, the extracted biographical data, and the one or more points of the portrait is compared with previously stored security information on the low-cost device. For example, the security information can encode the known or reference signature including the combination of the low-cost device identifier, the extracted biographical data, and the one or more points of the portrait. If the two combinations or signatures match or correspond, the identity document is determined to be authentic.

In some embodiments, the disclosed techniques capture, by a client device, an image depicting an identity document, the identity document comprising biographical data and a portrait. The disclosed techniques generate a hash based on the biographical data and generate a biometric representation based on the portrait. The disclosed techniques access security information associated with the identity document and compare the security information to at least one of the hash or biometric representation. The disclosed techniques authenticate the identity document based on a result of comparing the security information to at least one of the hash or biometric representation. In this way, the disclosed techniques provide a low-cost solution to ensuring identity documents and information printed on such documents is authentic.

In some examples, after verifying authenticity of an identity document, access to a secure resource or entry into a secure physical location or region is automatically granted. Specifically, an identity document can be presented to a reader that is installed at an entry point to a secure location. After the reader verifies authenticity of the identity document and confirms that the individual named or identified on the identity document (e.g., an employee or user identifier and/or name) is on an authorized list of individuals, the reader communicates an access instruction to a security component (e.g., a gate) to cause the security component to grant access (e.g., open the gate).

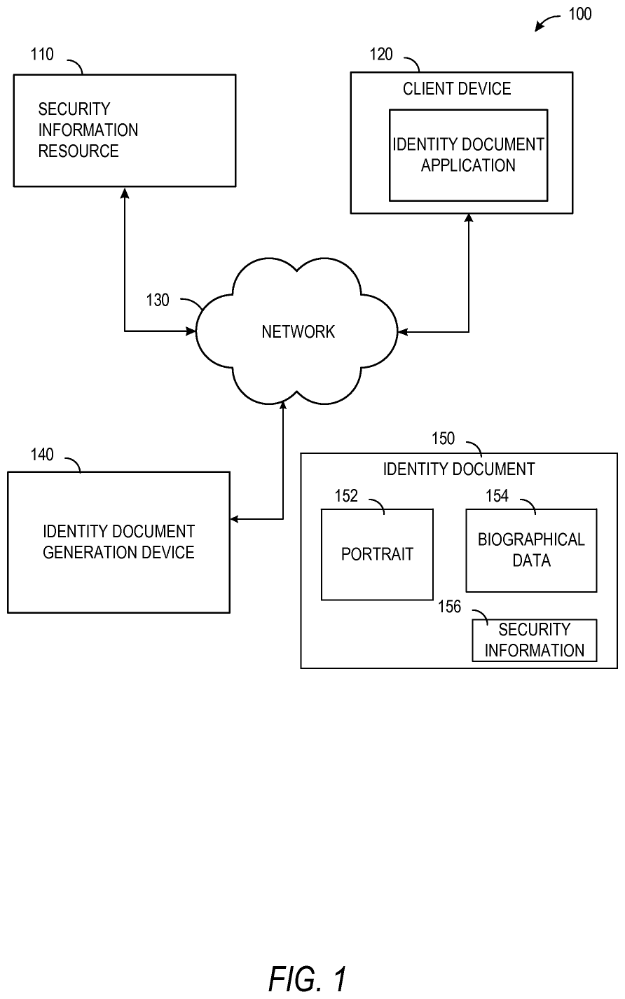

FIG. 1 is a block diagram showing an example identity document authentication system 100, according to various example embodiments. The identity document authentication system 100 can include a client device 120, a security information resource 110 that can store security information and be used to control access to a protected asset or resource, such as through a lockable door, an identity document generation device 140, and an identity document 150 that are communicatively coupled over a network 130 (e.g., Internet, BLE, ultra-wideband (UWB) communication protocol, telephony network).

The client device 120 and the security information resource 110 can be communicatively coupled via electronic messages (e.g., packets exchanged over the Internet, BLE, UWB, WiFi direct or any other protocol). While FIG. 1 illustrates a single security information resource 110 and a single client device 120, it is understood that a plurality of security information resources 110 and a plurality of client devices 120 can be included in the identity document authentication system 100 in other embodiments.

The security information resource 110 can include any one or a combination of an IoT device, a database, a website, a server hosting a website at a URL address, a physical access control device, logical access control device, governmental entity device, ticketing event device, and residential smart lock and/or other Bluetooth or NFC or UWB based smart device. In some examples, the security information resource 110 can be part of the client device 120. In some examples, the security information resource 110 is external to the client device 120 and communicates with the client device 120 over a network 130.

The security information resource 110 can protect a secure area, asset or resource and can be configured to receive a digital credential or digital credentials from the client device 120. In some cases, the client device 120 can authenticate an identity document 150. The client device 120 can, in response to determining that the identity document 150 is authentic, provide one or more extracted portions of the identity document 150 to the security information resource 110 as the digital credential. The security information resource 110 can verify that the received digital credential is authorized to access the secure area and, in response, the security information resource 110 can grant access to the secure area. The security information resource 110 itself or by communication with another server (not shown) can verify whether the digital credentials are authorized to access the identified secure resource. If so, the security information resource 110 can grant access to the client device 120 (e.g., by unlocking an electronic door lock) or individual associated with the client device 120. In some cases, some or all of the components and functionality of the security information resource 110 can be included in the client device 120 and/or in the identity document generation device 140.

As used herein, the term “client device” may refer to any machine that interfaces to a communications network (such as network 130) to exchange identity document information (e.g., credentials) with the security information resource 110, a physical mechanism that protects an asset, resource or secure location, another client device 120 or any other component to obtain access to the asset or resource protected by the security information resource 110. A client device 120 may be, but is not limited to, a mobile phone, desktop computer, laptop, portable digital assistant (PDA), smart phone, a wearable device (e.g., a smart watch), tablet, ultrabook, netbook, laptop, multi-processor system, microprocessor-based or programmable consumer electronics, or any other communication device that a user may use to access the network 130.

The security information resource 110 (and/or the client device 120) can include or be associated with a physical access control device that can include or be associated with an access reader device connected to a physical resource (e.g., a door locking mechanism or backend server) that controls the physical resource (e.g., door locking mechanism). The physical resource associated with the physical access control device can include a door lock, an ignition system for a vehicle, or any other device that grants or denies access to a secure resource or component, such as a physical component, and that can be operated to grant or deny access to the secure resource or component. For example, in the case of a door lock, the physical access control device can deny access, in which case the door lock remains locked and the door cannot be opened, or can grant access, in which case the door lock becomes unlocked to allow the door to be opened. As another example, in the case of an ignition system, the physical access control device can deny access, in which case the vehicle ignition system remains disabled and the vehicle cannot be started, or can grant access, in which case the vehicle ignition becomes enabled to allow the vehicle to be started.

Physical access control covers a range of systems and methods to govern access, for example by people, to secure areas or secure assets. Physical access control includes identification of authorized users or devices (e.g., vehicles, drones, etc.) and actuation of a gate, door, or other facility used to secure an area or actuation of a control mechanism, e.g., a physical or electronic/software control mechanism, permitting access to a secure asset. The physical access control device forms part of a physical access control system (PACS), which can include a reader (e.g., an online or offline reader) that holds authorization data and can be capable of determining whether credentials (e.g., from credential or key devices such as radio frequency identification (RFID) chips in cards, fobs, or personal electronic devices such as mobile phones) are authorized for an actuator or control mechanism (e.g., door lock, door opener, software control mechanism, turning off an alarm, etc.), or PACS can include a host server to which readers and actuators are connected (e.g., via a controller) in a centrally managed configuration. In centrally managed configurations, readers can obtain credentials from credential or key devices (e.g., identity document 150) and pass those credentials to the PACS host server. The host server then determines whether the credentials authorize access to the secure area or secure asset and commands the actuator or other control mechanism accordingly.

In general, the security information resource 110 can include one or more of a memory, a processor, one or more antennas, a communication module, a network interface device, a user interface, and a power source or supply. The memory of the security information resource 110 can be used in connection with the execution of application programming or instructions by the processor of the security information resource 110, and for the temporary or long-term storage of program instructions or instruction sets and/or credential or authorization data, such as credential data, credential authorization data, or access control data or instructions. For example, the memory can contain executable instructions that are used by the processor to run other components of security information resource 110 and/or to make access determinations based on credential or authorization data.

The memory of the security information resource 110 can comprise a computer readable medium that can be any medium that can contain, store, communicate, or transport data, program code, or instructions for use by or in connection with security information resource 110. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device.

The processor of the security information resource 110 can correspond to one or more computer processing devices or resources. For instance, the processor can be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor can be provided as a microprocessor, Central Processing Unit (CPU), or plurality of microprocessors or CPUs that are configured to execute instruction sets stored in an internal memory and/or memory of the security information resource 110.

The antenna of the security information resource 110 can correspond to one or multiple antennas and can be configured to provide for wireless communications between security information resource 110 and a credential or key device (e.g., client device 120 and/or identity document 150). The antenna can be arranged to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. By way of example, the antenna(s) can be RF antenna(s), and as such, may transmit/receive RF signals through free-space to be received/transferred by a credential or key device having an RF transceiver. In some cases, at least one antenna is an antenna designed or configured for transmitting and/or receiving UWB signals (referred to herein for simplicity as a “UWB antenna”) such that the reader can communicate using UWB techniques with the client device 120.

A communication module of the security information resource 110 can be configured to communicate according to any suitable communications protocol with one or more different systems or devices either remote or local to security information resource 110, such as one or more client devices 120.

The network interface device of the security information resource 110 includes hardware to facilitate communications with other devices, such as a one or more client devices 120 and/or an identity document 150, over a communication network, such as network 130, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface devices can include an Ethernet port or other physical jack, a Wi-Fi card, a Network Interface Card (NIC), a cellular interface (e.g., antenna, filters, and associated circuitry), or the like. In some examples, network interface devices can include a plurality of antennas to wirelessly communicate using at least one of single-input multiple-output (SIMO), multiple-input multiple-output (MIMO), or multiple-input single-output (MISO) techniques.

A user interface of the security information resource 110 can include one or more input devices and/or display devices. Examples of suitable user input devices that can be included in the user interface include, without limitation, one or more buttons, a keyboard, a mouse, a touch-sensitive surface, a stylus, a camera, a microphone, etc. Examples of suitable user output devices that can be included in the user interface include, without limitation, one or more LEDs, an LCD panel, a display screen, a touchscreen, one or more lights, a speaker, and so forth. It should be appreciated that the user interface can also include a combined user input and user output device, such as a touch-sensitive display or the like.

The network 130 may include, or operate in conjunction with, an ad hoc network, an intranet, an extranet, a virtual private network (VPN), a LAN, a wireless network, a wireless LAN (WLAN), a wide area network (WAN), a wireless WAN (WWAN), a metropolitan area network (MAN), BLE, UWB, the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other short range or long range protocols, or other data transfer technology.

The security information resource 110 (or some components of the security information resource 110) can be implemented or integrated into the identity document 150. For example, a portion of the security information resource 110 can be included as security information 156 of the identity document 150. Specifically, the security information 156 of the identity document 150 can implement an electronic device (e.g., a low cost processor) that stores or provides a link to security information that encodes a portrait 152 and/or biographical data 154 that is printed on the identity document 150. In some examples, the security information 156 includes a QR code printed on the identity document 150. When scanned, the QR code encodes a link or URL to a website or webpage that hosts or provides access to, such as on a one-time basis, to the portrait 152 and/or biographical data 154 or encoded version thereof.

In some embodiments, the client device 120 implements an identity document application. The identity document application may run on the client device 120 and can be accessed by a user of the client device 120. The identity document application can allow an operator or user to scan or capture a picture or image of the identity document 150. The identity document application can also obtain security information 156 associated with the identity document 150 that has been scanned. The identity document application retrieves security information that encodes a reference version of the portrait 152 (e.g., depicting a face of a person) and/or biographical data 154 printed on the identity document 150. The identity document application can compare the reference version of the portrait and biographical data to extracted or generated versions of the portrait 152 and/or biographical data 154 (or biographical information) printed on the identity document 150. The identity document application determines that the reference version matches or corresponds to the extracted portion or portions of the portrait 152 and/or biographical data 154. In response, the identity document application determines that the identity document 150 is authentic. In some cases, the identity document application generates digital credentials using one or more of the portrait 152 and/or biographical data 154 and/or the security information and provides the digital credentials to the security information resource 110 to provide access to a secure or protected resource.

In some examples, the identity document 150 is generated by the identity document generation device 140. In some cases, the security information 156 is generated by the identity document generation device 140 using information printed on the identity document 150. Namely, the identity document generation device 140 can generate all of the information printed on the identity document 150 including the security information 156. In some cases, the identity document generation device 140 accesses an already printed identity document 150 and is configured to reprogram the security information 156 that is included in or associated with the identity document 150.

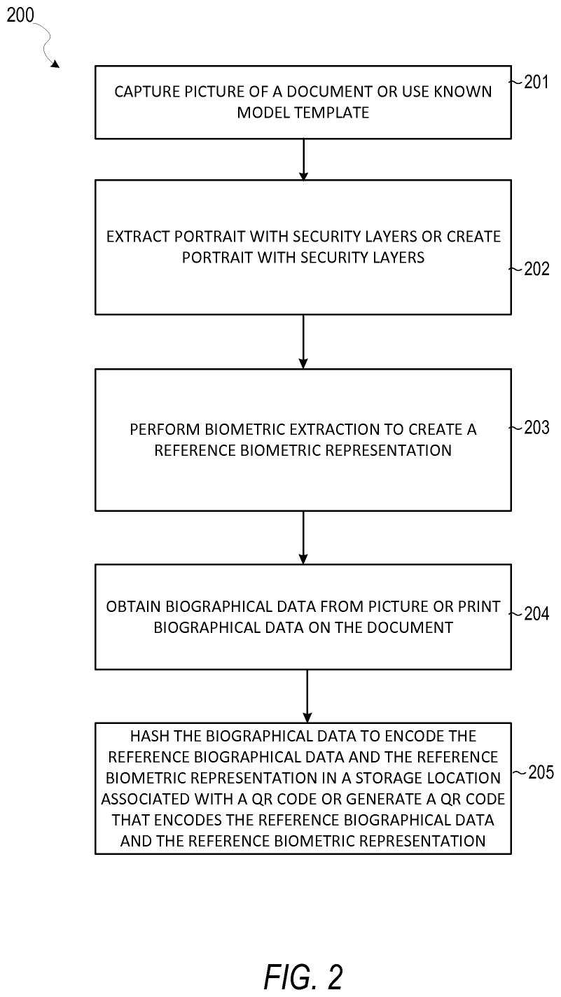

Specifically, the identity document generation device 140 can perform a process 200 to generate the security information 156 and/or the identity document 150 and encode such information in a QR code associated with the identity document 150. FIG. 2 is a flowchart illustrating the example process 200 of the identity document authentication system 100, according to example embodiments. The process 200 may be embodied in computer-readable instructions for execution by one or more processors such that the operations of the process 200 may be performed in part or in whole by the functional components of the identity document authentication system 100, such as the identity document generation device 140; accordingly, the process 200 is described below by way of example with reference thereto. However, in other embodiments, at least some of the operations of the process 200 may be deployed on various other hardware configurations. Some or all of the operations of process 200 can be in parallel, out of order, or entirely omitted.

In the case of accessing an already printed identity document 150, at operation 201, the identity document generation device 140 captures a picture or image of the identity document 150. In the case of having to generate or print a new identity document 150, the identity document generation device 140, at operation 201, uses a known model template and a portrait of face and biographical information input by a user to place the portrait of face and biographical information in specific positions on an identity card corresponding to the known model template.

At operation 202, in the case of accessing an already printed identity document 150, the identity document generation device 140 extracts the existing portrait 152 with or without security layers from the already printed identity document 150. For example, the identity document generation device 140 performs facial recognition or object recognition on the identity document 150 to extract only the portrait 152 from the identity document 150. In the case of generating a new identity document 150, the identity document generation device 140 obtains a portrait of a face (e.g., captured by a camera) and optionally embeds or overlays one or more security layers on the portrait of the face according to instructions of the known model template.

The identity document generation device 140, at operation 203, performs biometric extraction to create a reference biometric representation of the portrait 152 (printed on the identity document 150) or the portrait of the face with the optionally embedded security layers that was generated by capturing an image of a person's face. The identity document generation device 140 can, in some cases, select a specific configuration or subset of points on the portrait of the face and store pixel values of the subset of the points as the reference biometric representation. In this way, the reference biometric representation can encode less than all of the entire portrait of the face that is extracted or generated.

At operation 204, in the case of accessing an already printed identity document 150, the identity document generation device 140 obtains biographical data from the identity document 150. To do so, the identity document generation device 140 performs OCR on the captured image of the identity document 150 and extracts some or all of the words or text printed on the identity document 150 corresponding to the biographical data 154. In the case of generating a new identity document 150, the identity document generation device 140 prints the biographical data received from a user on a new identity document 150 according to the known model template. The identity document generation device 140 generates a reference biographical data using some or all of the extracted, received or detected biographical data 154.

At operation 205, the identity document generation device 140 hashes the biographical data 154 (extracted, received or detected at operation 204) to generate the reference biographical data. The identity document generation device 140 then stores the reference biographical data and the reference biometric representation in a storage location associated with a QR code that is printed on the identity document 150. In another implementation, the identity document generation device 140 generates a new QR code that encodes the reference biographical data and the reference biometric representation and prints the QR code on a new identity document 150. For example, the identity document generation device 140 can generate a webpage associated with a URL and store the webpage on the security information resource 110. The webpage can encode security information that includes the reference biographical data and the reference biometric representation. The webpage can store an encoded combination of the reference biographical data and the reference biometric representation. The URL can be encoded in a QR code which enables a client device 120 to access the webpage to retrieve the security information. In some cases, the webpage is associated with a one-time passcode (OTP). The webpage can be accessed when the OTP is provided. The QR code can then be printed on the identity document 150, such as by placing a sticker with the QR code on the identity document 150 and/or can be stored on an RF device associated with and embedded in the identity document 150.

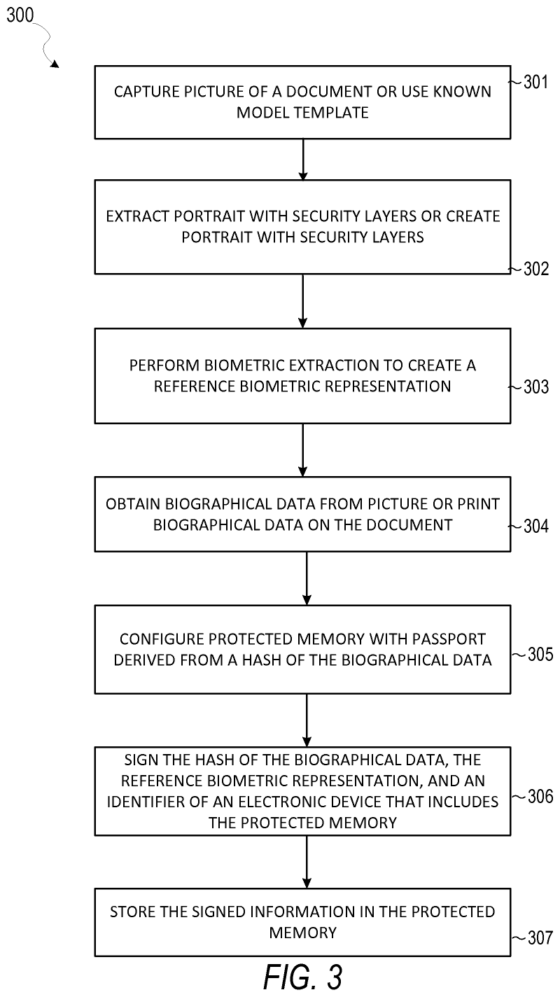

The identity document generation device 140 can perform a process 200 to generate the security information 156 and/or the identity document 150 and encode such information in a security device (embedded processor or low-cost processor) associated with the identity document 150. FIG. 3 is a flowchart illustrating the example process 300 of the identity document authentication system 100, according to example embodiments. The process 300 may be embodied in computer-readable instructions for execution by one or more processors such that the operations of the process 300 may be performed in part or in whole by the functional components of the identity document authentication system 100, such as the identity document generation device 140; accordingly, the process 300 is described below by way of example with reference thereto. However, in other embodiments, at least some of the operations of the process 300 may be deployed on various other hardware configurations. Some or all of the operations of process 300 can be in parallel, out of order, or entirely omitted.

In the case of accessing an already printed identity document 150, at operation 301, the identity document generation device 140 captures a picture or image of the identity document 150. In the case of having to generate or print a new identity document 150, the identity document generation device 140, at operation 301, uses a known model template and a portrait of face and biographical information input by a user to place the portrait of face and biographical information in specific positions on an identity card corresponding to the known model template.

At operation 302, in the case of accessing an already printed identity document 150, the identity document generation device 140 extracts the existing portrait 152 with or without security layers from the already printed identity document 150. For example, the identity document generation device 140 performs facial recognition or object recognition on the identity document 150 to extract only the portrait 152 from the identity document 150. In the case of generating a new identity document 150, the identity document generation device 140 obtains a portrait of a face (e.g., captured by a camera) and optionally embeds or overlays one or more security layers on the portrait of the face according to instructions of the known model template.

The identity document generation device 140, at operation 303, performs biometric extraction to create a reference biometric representation of the portrait 152 (printed on the identity document 150) or the portrait of the face with the optionally embedded security layers that was generated by capturing an image of a person's face. The identity document generation device 140 can, in some cases, select a specific configuration or subset of points on the portrait of the face and store pixel values of the subset of the points as the reference biometric representation. In this way, the reference biometric representation can encode less than all of the entire portrait of the face that is extracted or generated.

At operation 304, in the case of accessing an already printed identity document 150, the identity document generation device 140 obtains biographical data (information) from the identity document 150. To do so, the identity document generation device 140 performs OCR on the captured image of the identity document 150 and extracts some or all of the words or text printed on the identity document 150 corresponding to the biographical data 154. In the case of generating a new identity document 150, the identity document generation device 140 prints the biographical data received from a user on a new identity document 150 according to the known model template. The identity document generation device 140 generates a reference biographical data using some or all of the extracted, received or detected biographical data 154.

At operation 305, the identity document generation device 140 hashes the biographical data 154 (extracted, received or detected at operation 304) to generate the reference biographical. The identity document generation device 140 configures protected memory of the security information 156 (e.g., storage element or processor) embedded in the identity document 150 with a passport or password corresponding to the reference biographical data or hash of the reference biographical data.

At operation 306, the identity document generation device 140 obtains an identifier, such as a unique identifier or serial number, of the storage element or processor that stores the security information 156 on the identity document 150. The identity document generation device 140 signs the hash of the reference biographical data, the reference biometric representation, and the identifier of the storage element or processor. Namely, the identity document generation device 140 generates a unique signature that represents a combination of the hash of the reference biographical data, the reference biometric representation, and the identifier of the storage element or processor.

At operation 307, the identity document generation device 140 stores the unique signature in the protected memory of the storage element or processor of the security information 156. For example, the identity document generation device 140 can encrypt the unique signature based on the hash of the reference biographical data and store the encrypted data as the security information 156 stored on the identity document 150.

In some examples, rather than storing the signature, the identity document generation device 140 may only store the biometric representation in the protected memory. Namely, the identity document generation device 140 can encrypt the biometric representation using the hash of the reference biographical data and store that data on the protected memory.

After the security information 156 is stored on the identity document 150 and/or is stored on the security information resource 110 associated with the identity document 150 (e.g., on a webpage referenced by a URL encoded in a QR code), the identity document 150 can be accessed or processed by the client device 120 and used to access a secure or protected physical area or resource.

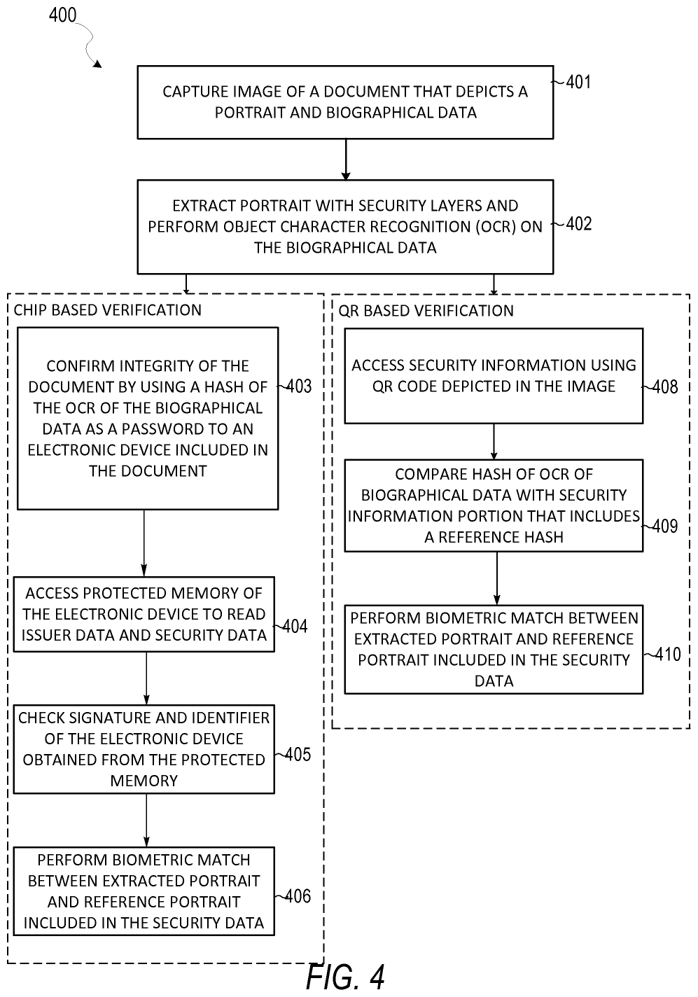

FIG. 4 is a flowchart illustrating example process 400 of the identity document authentication system 100, according to example embodiments. The process 400 may be embodied in computer-readable instructions for execution by one or more processors such that the operations of the process 400 may be performed in part or in whole by the functional components of the identity document authentication system 100, such as the client device 120 and/or the security information resource 110; accordingly, the process 400 is described below by way of example with reference thereto. However, in other embodiments, at least some of the operations of the process 400 may be deployed on various other hardware configurations. Some or all of the operations of process 400 can be in parallel, out of order, or entirely omitted.

At operation 401, the client device 120 captures an image of a document that depicts a portrait and biographical data. For example, the client device 120 can include a camera that takes a picture of the printed information on the identity document 150 including the portrait 152 (with or without security layers) and biographical data 154 and/or security information 156 (e.g., in case the security information 156 is represented by a QR code printed on the identity document 150).

At operation 402, the client device 120 extracts the portrait with or without security layers and performs OCR on the biographical data. For example, the client device 120 processes the captured image using facial recognition to extract the portrait 152 from the captured image. In some cases, the client device 120 applies a known model or template of the identity document 150 and crops out the portion of the image of the identity document 150 that corresponds to the portrait 152 to extract the portrait 152. Similarly, the client device 120 can use a known model or template of the identity document 150 to scan or perform OCR to extract the text or words representing the biographical data 154.

In case the security information 156 is encoded by or referenced by a chip, such as an embedded low-cost processor on the identity document 150, the client device 120 performs a first set of operations (e.g., operations 403, 404, 405 and 406) to verify or validate authenticity of the identity document 150. In case the security information 156 is encoded by or referenced by a QR code printed on the identity document 150, the client device 120 performs a second set of operations (e.g., operations 408, 409 and 410) to verify or validate authenticity of the identity document 150.

In some examples, at operation 403, the client device 120 confirms integrity of the identity document 150 by using a hash of the OCR of the biographical data as a password or passport to an electronic device or protected memory of the electronic device included in the identity document 150. If access is granted to the protected memory, at operation 404, the protected memory of the electronic device is accessed to read issuer data and/or security data (e.g., security information 156).

At operation 405, a signature and/or identifier of the electronic device retrieved from the protected memory is checked or verified against a known or reference signature and/or a known or reference identifier (e.g., serial number) of the electronic device embedded in the identity document 150. If the signature and/or identifier of the electronic device is valid, reference biometric information is retrieved from the protected memory. At operation 406, the client device 120 performs a biometric match or comparison between the extracted portrait and the reference portrait (e.g., the reference biometric information) included in the security data. In some cases, a specified set of points of the extracted portrait are compared with a specified set of points provided by the reference portrait. If the two sets of points match each other by more than a threshold amount, the identity document 150 is determined to be authentic. In some cases, the client device 120 also verifies that the extracted biographical data matches previously stored reference biographical data to determine that the identity document 150 is authentic.

In some examples, the client device 120 generates a new signature by combining or encoding the OCR of the biographical data, the extracted portrait (or portions thereof) and identifier of the electronic device. The client device 120 can then retrieve a known or reference signature from the protected memory of the electronic device and compare the reference signature with the generated new signature. If the two signatures match or correspond to each other, the client device 120 generates an instruction indicating that the identity document 150 is authentic and can be used to unlock or access a protected resource.

In some examples, rather than retrieving the security data from the local device of the identity document 150, the client device 120 obtains a URL and OTP from the electronic device embedded in the identity document 150. The client device 120 can access the security information 156 from a remote server at an address corresponding to the URL and based on the OTP. In some cases, the client device 120 only receives the URL from the local device and uses the URL to access or receive an OTP from a remote server associated with the URL. The OTP can then be used to unlock an protected memory of the device of the identity document 150 to retrieve the security information 156 (e.g., reference biometric information and/or reference biographical data). The security information 156 can be compared with actual printed contents of the identity document 150 (e.g., by performing OCR and image recognition to extract relevant data) to determine whether the identity document 150 is authentic.

In some examples, at operation 408, the client device 120 accesses security information using a QR code depicted in the image of the identity document 150. The security information can be accessed or retrieved from a URL referenced by the QR code and hosted by the security information resource 110. At operation 409, the client device 120 compares a hash of the OCR of the biographical data 154 with a security information portion that includes a reference hash. In parallel with operation 409, before or after operation 409, the client device, at operation 410, performs a biometric match or comparison between the extracted portrait and a reference portrait included in the security information. If the client device 102 determines that both the hash of the OCR and the extracted portrait match the reference hash and the reference portrait, the client device 120 generates an instruction indicating that the identity document 150 is authentic and can be used to unlock or access a protected resource.

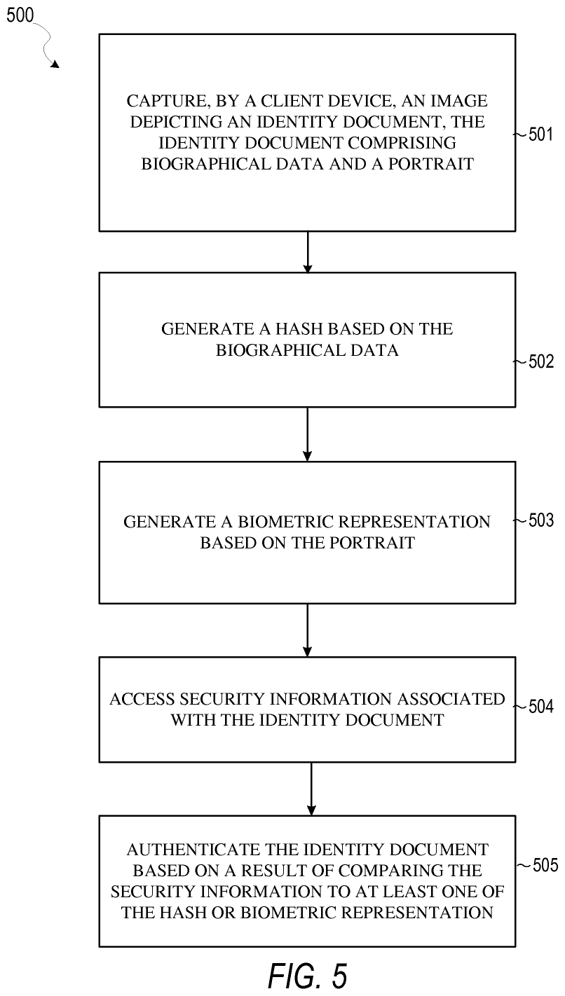

FIG. 5 is a flowchart illustrating example process 500 of the identity document authentication system 100, according to example embodiments. The process 500 may be embodied in computer-readable instructions for execution by one or more processors such that the operations of the process 500 may be performed in part or in whole by the functional components of the identity document authentication system 100; accordingly, the process 500 is described below by way of example with reference thereto. However, in other embodiments, at least some of the operations of the process 500 may be deployed on various other hardware configurations. Some or all of the operations of process 500 can be in parallel, out of order, or entirely omitted.

At operation 501, the identity document authentication system 100 captures, by the client device 120, an image depicting an identity document, the identity document comprising biographical data and a portrait, as discussed above.

At operation 502, the identity document authentication system 100 generates a hash based on the biographical data, as discussed above.

At operation 503, the identity document authentication system 100 generates a biometric representation based on the portrait, as discussed above.

At operation 504, the identity document authentication system 100 accesses security information associated with the identity document, as discussed above.

At operation 505, the identity document authentication system 100 authenticates the identity document based on a result of comparing the security information to at least one of the hash or biometric representation, as discussed above.

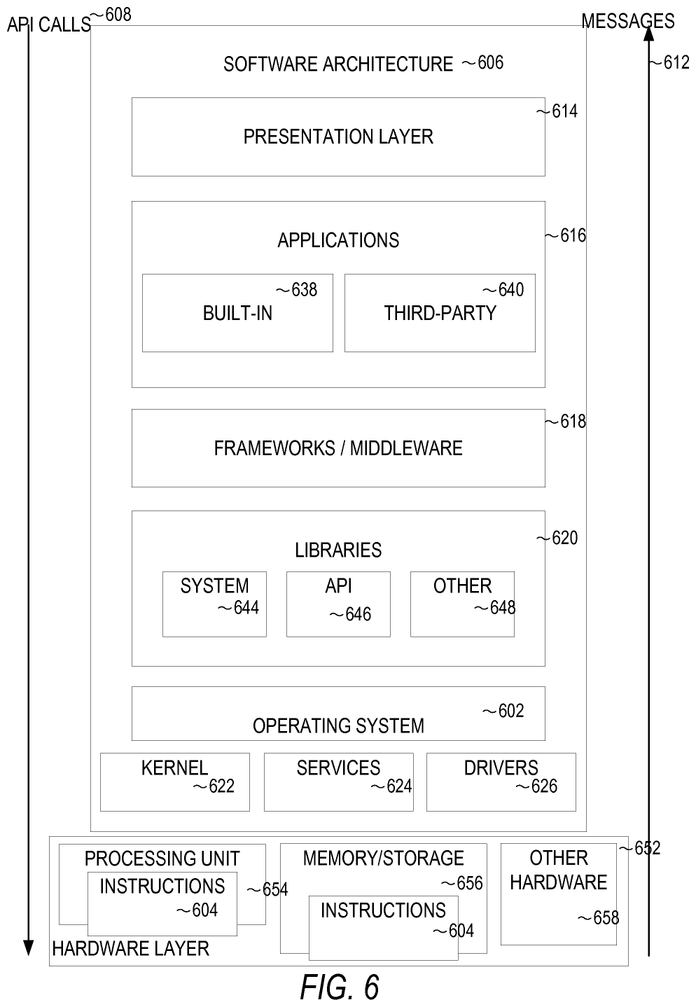

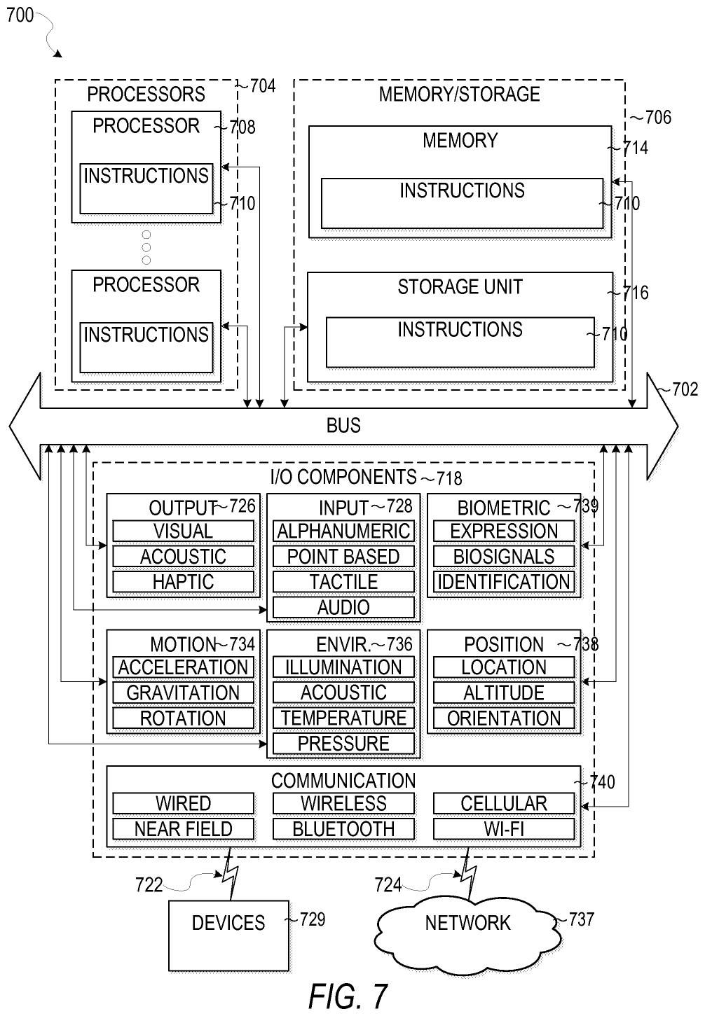

FIG. 6 is a block diagram illustrating an example software architecture 606, which may be used in conjunction with various hardware architectures herein described. FIG. 6 is a non-limiting example of a software architecture and it will be appreciated that many other architectures may be implemented to facilitate the functionality described herein. The software architecture 606 may execute on hardware such as machine 700 of FIG. 7 that includes, among other things, processors 704, memory 714, and input/output (I/O) components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage devices memory/storage 656, which also have executable instructions 604. The hardware layer 652 may also comprise other hardware 658. The software architecture 606 may be deployed in any one or more of the components shown in FIG. 1.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke API calls 608 through the software stack and receive messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, BLE drivers, UWB drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624 and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPREG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/devices.

The frameworks/middleware 618 (also sometimes referred to as middleware) provide a higher-level common infrastructure that may be used by the applications 616 and/or other software components/devices. For example, the frameworks/middleware 618 may provide various graphic user interface functions, high-level resource management, high-level location services, and so forth. The frameworks/middleware 618 may provide a broad spectrum of other APIs that may be utilized by the applications 616 and/or other software components/devices, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built-in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed.

As such, the instructions 710 may be used to implement devices or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. In an example embodiment, the processors 704 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 708 and a processor 712 that may execute the instructions 710. The term “processor” is intended to include multi-core processors 704 that may comprise two or more independent processors (sometimes referred to as “cores”) that may execute instructions contemporaneously. Although FIG. 7 shows multiple processors 704, the machine 700 may include a single processor with a single core, a single processor with multiple cores (e.g., a multi-core processor), multiple processors with a single core, multiple processors with multiple cores, or any combination thereof.

The memory/storage 706 may include a memory 714, such as a main memory, or other memory storage, instructions 710, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a LED display, a LCD, a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 739, motion components 734, environmental components 736, or position components 738 among a wide array of other components. For example, the biometric components 739 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 737 or devices 729 via coupling 724 and coupling 722, respectively. For example, the communication components 740 may include a network interface component or other suitable device to interface with the network 737. In further examples, communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 729 may be another machine or any of a wide variety of peripheral devices (e.g., a peripheral device coupled via a USB).

Moreover, the communication components 740 may detect identifiers or include components operable to detect identifiers. For example, the communication components 740 may include RFID tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

### Glossary

“CARRIER SIGNAL” in this context refers to any intangible medium that is capable of storing, encoding, or carrying transitory or non-transitory instructions for execution by the machine, and includes digital or analog communications signals or other intangible medium to facilitate communication of such instructions. Instructions may be transmitted or received over the network using a transitory or non-transitory transmission medium via a network interface device and using any one of a number of well-known transfer protocols.

“COMMUNICATIONS NETWORK” in this context refers to one or more portions of a network that may be an ad hoc network, an intranet, an extranet, a VPN, a LAN, a BLE network, a UWB network, a WLAN, a WAN, a WWAN, a metropolitan area network (MAN), the Internet, a portion of the Internet, a portion of the PSTN, a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device, or other tangible media able to store instructions and data temporarily or permanently and may include, but is not limited to, RAM, ROM, buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a FPGA or an ASIC. A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a CPU, a RISC processor, a CISC processor, a GPU, a DSP, an ASIC, a RFIC, or any combination thereof. A processor may further be a multi-core processor having two or more independent processors (sometimes referred to as “cores”) that may execute instructions contemporaneously.

Changes and modifications may be made to the disclosed embodiments without departing from the scope of the present disclosure. These and other changes or modifications are intended to be included within the scope of the present disclosure, as expressed in the following claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A method comprising:
capturing an image depicting an identity document, the identity document comprising biographical data and a portrait;
generating a hash based on the biographical data;
generating a biometric representation based on the portrait;
accessing security information associated with the identity document;
comparing the security information to at least one of the hash or biometric representation; and
authenticating the identity document based on a result of comparing the security information to at least one of the hash or biometric representation.

2. The method of claim 1, wherein the identity document comprises an electronic identity card or electronic passport, the portrait depicting a face of a person.

3. The method of claim 1, further comprising:
extracting reference hash and biometric information from the security information; and
comparing the reference hash and biometric information to the generated hash and biometric representation.

4. The method of claim 3, further comprising:
determining that the identity document is authentic in response to determining that the reference hash and biometric information corresponds to the generated hash and biometric representation.

5. The method of claim 3, further comprising:
determining that the identity document is not authentic in response to determining that one or more of the reference hash and biometric information fails to correspond to the generated hash and biometric representation.

6. The method of claim 1, wherein the security information is accessed from a remote server by accessing a link encoded on a reference included in the identity document.

7. The method of claim 1, wherein the security information is accessed from a local electronic device embedded in the identity document.

8. The method of claim 1, wherein the portrait includes a security layer on top of a face of a person.

9. The method of claim 1, further comprising:
performing object character recognition on the image to extract the biographical data;
using face recognition to extract the portrait from the identity document;
generating the hash based on the extracted biographical data;
using the hash to access reference biometric information from a protected memory of an electronic device embedded in the identity document;
verifying an issuer signature retrieved from the protected memory;
confirming a retrieved identifier of electronic device matches an identifier of the electronic device stored in the protected memory; and
comparing the reference biometric information to the extracted portrait to determine whether the identity document is authentic.

10. The method of claim 1, wherein accessing the security information comprises:
obtaining a universal resource locator (URL) from an electronic device embedded in the identity document; and
retrieving the security information from the URL.

11. The method of claim 10, wherein the electronic device provides a one-time passcode (OTP) in addition to the URL, wherein the security information is retrieved from the URL based on the OTP.

12. The method of claim 1, wherein a secure portion of an electronic device embedded in the identity document is accessed using the generated hash of the biographical data.

13. The method of claim 1, wherein a secure portion of an electronic device embedded in the identity document is accessed using a portion of the biographical data.

14. The method of claim 1, further comprising accessing a remote database storing a status indicating validity of the security information.

15. A method for generating security information, the method comprising:
using face recognition to extract a portrait from an identity document;
transforming at least a portion of the extracted portrait into a reference biometric information;
performing object character recognition on the identity document to extract biographical data;
generating a reference hash using the extracted biographical data; and
storing the reference biometric information in a protected memory using the reference hash.

16. The method of claim 15, further comprising storing the security information locally on the identity document or remotely on a server.

17. The method of claim 15, further comprising:
retrieving an identifier of an electronic device embedded in the identity document; and
signing the identifier of the electronic device, the reference biometric information, and the reference hash.

18. The method of claim 15, further comprising:
storing the reference hash in the protected memory.

19. A system comprising:
one or more processors configured to perform operations comprising:
capturing an image depicting an identity document, the identity document comprising biographical data and a portrait;
generating a hash based on the biographical data;
generating a biometric representation based on the portrait;
accessing security information associated with the identity document;
comparing the security information to at least one of the hash or biometric representation; and
authenticating the identity document based on a result of comparing the security information to at least one of the hash or biometric representation.

20. A non-transitory computer-readable medium comprising non-transitory computer-readable instructions that, when executed by one or more processors, configure the one or more processors to perform operations comprising:
capturing an image depicting an identity document, the identity document comprising biographical data and a portrait;
generating a hash based on the biographical data;
generating a biometric representation based on the portrait;
accessing security information associated with the identity document;
comparing the security information to at least one of the hash or biometric representation; and
authenticating the identity document based on a result of comparing the security information to at least one of the hash or biometric representation.
